(19) United States
(12) Patent Application Publication
(10) Pub. No.: US 2018/0139972 A1
(43) Pub. Date: May 24, 2018

(54) GLUTEN-FREE OR GLUTEN-REDUCED BREAD DOUGH

(71) Applicant: NESTEC S.A., Vevey (CH)

(72) Inventors: Tilman Johannes Schober, Aurora, OH (US); Baninder Singh Sroan, Hudson, OH (US)

(21) Appl. No.: 15/305,746

(22) PCT Filed: May 5, 2015
(86) PCT No.: PCT/EP2015/059782

§ 371 Date: Oct. 21, 2016

Related U.S. Application Data
(60) Provisional application No. 61/991,047, filed on May 9, 2014.

(51) Int. Cl. A21D 13/066; A21D 2/18; A21D 2/36

(52) U.S. Cl. CPC A21D 13/066; A21D 2/36; A21D 2/188; A21D 2/186

(57) ABSTRACT

The present invention relates to a gluten-free or gluten-reduced bread dough comprising corn starch, potato starch and tapioca starch. Further aspects of the invention are the method for the preparation of a gluten-free or gluten-reduced bread dough product as well as baked dough products prepared by said method.

### FIELD OF THE INVENTION

The present invention relates to a gluten-free or gluten-reduced bread dough comprising corn starch, potato starch and tapioca starch. Further aspects of the invention are the method for the preparation of a gluten-free or gluten-reduced bread dough product as well as baked dough products prepared by said method.

### BACKGROUND OF THE INVENTION

Bread products such as pan breads, pizza crusts or Panini breads are typically prepared from wheat flour. Wheat, however, contains substantial amounts of glutenin and gliadin, which form gluten as a protein composite during the bread making process. Gluten is found in many food products which are processed from wheat and other related grain species, including barley and rye. Gluten gives cohesiveness, extensibility and elasticity to a wheat dough, helping it to rise and keep its shape, and often contributes to a final dough product with its chewy and soft texture. Generally, flours used in bread-making are high in gluten content, whereas typically flours used for making sweet pastry products have a lower gluten content.

Although important in bread-making, the presence of gluten can cause health problems in predisposed individuals, for example individuals affected by the coeliac disease. Coeliac disease is a life-long autoimmune disease of the small intestine and the only presently known effective treatment is a lifelong gluten-free diet. However, the exclusion of gluten consumption is not easy for coeliac patients because gluten-containing products include some of the most common foods, such as bread.

Since gluten contributes to the appearance and crumb structure of bread, its replacement is critical in achieving good quality gluten-free bread products. Indeed, many of the gluten-free bread products on the Market today are of lower or at least unsatisfactory quality, having poor mouthfeel, poor texture of the internal crumb part, fast crumb hardening, low specific bread volume and poor sensory attributes. In order to produce gluten-free or gluten-reduced breads with improved quality, many different solutions with using different flours, starches and in combination with many other substances such as enzymes, proteins and/or hydrocolloids have been proposed.

For example WO2010/006778 proposes a composition for preparing improved gluten-free or gluten-reduced bakery products, comprising an enzyme active soybean flour and at least one hydrocolloid, such as for example an alginate, a gum or a cellulose. Preferred was the addition of a xanthan gum and/or a guar gum.

US2010/0119652 discloses gluten-free formulations for the production of gluten-free bakery products, where the formulation comprises gluten-free starches which mimic the starch particle size found in wheat. Furthermore, proteins from different source than wheat and hydrocolloids are used in the formulation as well.

Also WO2010/009464 discloses a gluten-free composition which can be made into a bakery dough. The composition comprises gluten-free flour, starches, proteins selected from dairy, egg or soy proteins, and a combination of different gums.

Most of those disclosed gluten-free or gluten-reduced bread dough products, however, still have some disadvantages as for example:
a long list of ingredients which have to be labelled and which may not be appreciated by a consumer as he or she would not expect to find them in a ‘natural’ bread product, such as the presence of different gums and hydrocolloids, and the presence of soy proteins;
the presence of either egg, milk or soy proteins may pose problems for consumers with allergies against those proteins, and he or she may not want them to be present in a bread dough product;
cost considerations: the use of mixtures of gums and/or other proteins increases costs of production making such bread dough products unnecessary expensive.

Although already considerable efforts have been done in the food industry to provide good gluten-free bread dough products, many disadvantages of the provided solutions still persist, as mentioned above. Hence, there is still a clear need in the art and food industry to find alternative and/or better solutions for producing and providing gluten-free or gluten-reduced bread dough products.

### SUMMARY OF THE INVENTION

The object of the present invention is to improve the state of the art and to provide an improved or alternative gluten-free or gluten-reduced bread dough product and a solution for making the same in order to overcome at least some of the inconveniences and disadvantages described above.

The object of the present invention is achieved by the subject matter of the independent claims. The dependent claims further develop the idea of the present invention.

Accordingly, the present invention provides in a first aspect a gluten-free or gluten-reduced bread dough comprising 5-15 wt % corn starch, 10-25 wt % potato starch, 2-15 wt % tapioca starch, gluten-free or gluten-reduced flour, and water.

In a second aspect, the invention relates to a method for the preparation of a gluten-free or gluten-reduced bread dough product comprising the steps of:
a) mixing ingredients comprising 5-15 wt % corn starch, 10-25 wt % potato starch, 2-15 wt % tapioca starch, gluten-free or gluten-reduced flour, and water, to produce a dough;
b) shaping the dough into a form;
c) optionally proofing the dough; and
d) baking the dough in an oven.

A third aspect of the invention relates to a baked dough product prepared by baking the gluten-free or gluten-reduced bread dough of the present invention.

A still further aspect of the invention is a use of the gluten-free or gluten-reduced bread dough of the present invention for the preparation of a frozen or ready-to-eat food product.

It has been surprisingly found by the inventors that a very good quality gluten-free baked bread product can be obtained when baking a dough comprising gluten-free flour in combination with specific amounts of corn, potato and tapioca starch. The formulation allowed making a gluten-free pan bread and a gluten-free Pizza crust with a good quality bread texture characterized by a light, aerated crumb structure with uniform pores, and a glossy crispy crust. The inventors particularly found that it was the presence and combination of specific amounts of corn, potato and tapioca starch which resulted in the improved quality of the bread dough. As evidenced below in the Example section, the use of any of the above mentioned starches either individually or in other combinations did not provide very satisfactory results when baked e.g. in form of a pan or other bread product. It was only the specific combination of those starches with gluten-free flour as claimed in the present invention, which provided satisfactory results, particularly as to the structure and texture of the crumb.

The experiments conducted by the inventors were based on gluten-free bread dough's which did not contain any added proteins in the form of e.g. egg, milk or soybean proteins. Furthermore, the inventors did not make use of any gums such as guar gum, xanthan or gum Arabic. Despite the absence of those egg, dairy and soybean proteins and the absence of guar, xanthan and Arabic gums, the gluten-free bread dough of the present invention still provided very satisfactory bread dough products after baking and this as to texture of the crumb as well as to the organoleptic properties of the bread as a whole. Consequently, a gluten-free or gluten-reduced bread product can be made by using the bread dough of the present invention without making use or adding proteins selected from egg, milk or soy proteins, and without making use or adding gums selected from guar gum, xanthan gum or gum Arabic.

The advantage of the present gluten-free dough bread product is that it comprises only a limited amount of ingredients which are all perceived as ‘natural’ by today consumers and also perceived as natural ingredients a consumer would expect to find in a bread dough product. Furthermore, the dough bread product of the present invention does not comprise proteins which may induce some allergic reactions to consumers who suffer for example from egg protein, milk protein or soy protein food allergies. Consequently, the present invention provides a bread dough which is more ‘natural’, with less artificial ingredients and which still provides an excellent good quality bread product when baked. Furthermore, and equally important is the fact that the present invention allows to make gluten-free or gluten-reduced bread dough products at a lesser production cost as many of the ‘un-natural’ expensive ingredients can be omitted.

### BRIEF DESCRIPTION OF THE FIGURES

FIG. 1: Cross section of pizza crust produced with the formulation as in Table 5

FIG. 2: Slice of bread produced with the formulation as in Table 5

FIG. 3: Slice of bread produced with the formulation in Table 6 (HPMC included)

### DETAILED DESCRIPTION OF THE INVENTION

The present invention pertains to a gluten-free or gluten-reduced bread dough comprising: 5-15 wt % corn starch, 10-25 wt % potato starch, 2-15 wt % tapioca starch, gluten-free or gluten-reduced flour, and water.

The amounts provided herein as wt % relate to weight per-cent per total weight of the dough composition.

A “bread dough” pertains to a dough for making a bread product, such as for example a pan bread, a pizza bread or crust, a tortilla, a Panini bread or a Hot-pocket bread (filled sandwich).

“Gluten-free” means that the dough or flour in question does not comprise gluten.

“Gluten-reduced” pertains to a dough or a flour where the amount of gluten normally present in such a corresponding bread dough or flour product has been substantially reduced.

Typically, the gluten-free or gluten-reduced bread dough of the present invention comprises 5-37 wt % of a gluten-free or gluten-reduced flour. Furthermore, the gluten-free or gluten-reduced bread dough of the present invention preferably comprises a leavening agent which can be for example fresh or dried yeast, sugar as energy source for the yeast, and optionally some salt.

Preferably, the gluten-free or gluten-reduced flour is selected from the group consisting of whole grain flour and rice flour. Gluten-free whole grain flour typically includes for example brown rice flour, as well as whole grain flours from amaranth, quinoa, millet, sorghum, teff, buckwheat, corn (maize) and any other gluten-free grains or pseudo-cereals. Gluten-free or gluten-reduced whole grain flour is preferably selected in the present invention for its nutritional and further health beneficial properties.

In a further embodiment, the dough of the present invention further comprises up to 2 wt % of methyl-cellulose. Preferably the methyl-cellulose is selected from hydroxypropyl methyl-cellulose (HPMC). HPMC has the effect of stabilizing the gas cells, particularly in bread products which large proportions of crumb versus crust structures, and thereby to contribute to a finer and softer crumb.

In a preferred embodiment, the gluten-free or gluten-reduced bread dough of the present invention comprises 7-12 wt % corn starch. The corn starch contributes to a well-set, dry crumb part.

In a further preferred embodiment, the gluten-free or gluten-reduced bread dough of the present invention comprises 15-23 wt % potato starch. The potato starch contributes to the well-set, dry crumb part and contributes to a dry mouth-feel of a finished baked bread product, important for example for pizza-like bread products.

In a still further preferred embodiment, the gluten-free or gluten-reduced bread dough of the present invention comprises 3-10 wt % tapioca starch. Tapioca starch contributes moisture and gumminess to the crumb. High amounts of tapioca starch, i.e. more than 15 wt %, create an excessively gummy crumb structure. Preferably, tapioca starch is therefore present in amounts not exceeding 10 wt %. However, tapioca starch contributes to the moisture content of the crumb which otherwise would be too dry and cracked. Therefore, the dough of the present invention comprises at least 2 wt % tapioca starch, and preferably at least 3 wt % tapioca starch.

In another embodiment, the dough of the present invention further comprises 0.2-1.2 wt % citrus fiber, and preferably 0.4-1.0 wt % citrus fiber. Citrus fibers have the effect of providing a better dough consistency and of softening and stabilizing the crumb structure, particularly in bread products which large proportions of crumb versus crust structures, and thereby to contribute to a finer crumb part. Citrus fibers have also a nutritional benefit, as they are a natural ingredient increasing the soluble and insoluble fiber content in a finished product.

A preferred embodiment of the present invention is a gluten-free or gluten-reduced bread dough comprising: 10-11 wt % corn starch, 20-22 wt % potato starch, 5-6 wt % tapioca starch, 0.6-1.0 wt % citrus fiber, 10-20 wt % gluten-free flour, and water. Preferably, this embodiment further comprises 0.5-1.5 wt % salt, ca. 2 wt % sugar, ca. 2 wt % fresh yeast and 35-50 wt % water. Such a bread dough is well suited for making a gluten-free Pizza bread crust.

A further preferred embodiment of the present invention is a gluten-free or gluten-reduced bread dough comprising: 12-14 wt % corn starch, 17-19 wt % potato starch, 5-6 wt % tapioca starch, 0.6-1.0 wt % citrus fiber, 10-20 wt % gluten-free flour, and water. Preferably, this embodiment further comprises 0.5-1.5 wt % salt, ca. 2 wt % sugar, ca. 2-5 wt % fresh yeast and 35-50 wt % water. Such a bread dough is well suited for making a gluten-free Pizza bread crust.

Preferably, the bread dough of the present invention does not comprise egg proteins, dairy proteins and/or soy proteins. Thereby, advantageously, the bread dough of the present invention does not contain such proteins which are well known food allergens and can induce adverse immune reactions with consumers allergic to such egg, milk and/or soybean proteins.

Preferably also, the bread dough of the present invention does not comprise a gum. Particularly, it does not comprise a gum, where the gum is selected from the group consisting of guar gum, xanthan gum, gellan gum, gum Arabic, agar, alginate, carrageenan, locust bean gum, konjac gum, karaya gum, and tara gum. Such gum ingredients are perceived by consumers as ‘not natural’ and are typically not expected to be in a ‘normal’ bread product. Consequently, today's consumers usually prefer bread products which are made without the use of such artificial ingredients. It is an advantage of the present invention that such gum ingredients are not needed in the making of the gluten-free or gluten-reduced bread dough of the present invention. Hence, the present bread dough provides a more consumer friendly solution than what is presently known in the prior art.

A further aspect of the present invention pertains to a method for the preparation of a gluten-free or gluten-reduced bread dough product comprising the steps of: a) mixing ingredients comprising 5-15 wt % corn starch, 10-25 wt % potato starch, 2-15 wt % tapioca starch, gluten-free or gluten-reduced flour, and water, to produce a dough; b) shaping the dough into a form; c) optionally proofing the dough; and d) baking the dough in an oven. Preferably, steam is injected into the oven during the baking process or during part of the baking process. It was observed by the inventors that the use of steam during the baking process in the oven resulted for example in pizza bread crusts which had a much more glossy and smooth surface then when no steam was applied during the baking process. Absence of steam resulted in a more rough and dull surface, on which dried starch may be visible as a white layer. Furthermore, it seemed also that the surface of the bread crust was much less exposed to cracking during the baking process when steam was applied.

A still further aspect of the present invention pertains to a baked dough product prepared by baking the gluten-free or gluten-reduced bread dough of the present invention.

A still further aspect of the present invention pertains also to a baked dough product obtainable by the method of the present invention.

The baked dough product resulting from the baking of the bread dough of the present invention and/or obtainable from the method of the present invention, preferably is a pan bread, a pizza bread crust, a tortilla, a Panini bread, a Hot-pocket product, a pretzel, a pie or a sandwich bread product.

A still further aspect of the present invention is the use of the gluten-free or gluten-reduced bread dough of the present invention for the preparation of a frozen or ready-to-eat food product. Such a frozen or ready-to-eat food product can be a pan bread, a pizza bread crust, a tortilla, a Panini bread, a Hot-pocket product, a pretzel, a pie or a sandwich bread product.

Those skilled in the art will understand that they can freely combine all features of the present invention disclosed herein. In particular, features described for the dough product of the present invention may be combined with the method for preparation as well as the use of the dough, and vice versa. Further, features described for different embodiments of the present invention may be combined.

Further advantages and features of the present invention are apparent from the examples.

### Examples

### Example 1: Formulation of Dough Compositions

Different gluten-free bread dough compositions were formulated with the ingredients according to Table 1 and 2.

The compositions were made with the following ingredients:
A mixture of 3 starches (corn starch, potato starch, tapioca starch). These are isolated (chemically pure), native starches; they are not chemically or physically modified:
   Corn starch: Cargill Gel 03420, native common corn starch, moisture ≤12%; Cargill, Inc., Hammond, Ind.)
   Potato starch: PenPure 10, native potato starch, moisture ≤20% (Penford, Centennial, Colo.)
   Tapioca starch: PenPure 50, native tapioca starch, moisture ≤15% (Penford, Centennial, Colo.)
A gluten-free flour component: two different flours were used:
   Gluten-free 5 grain whole grain flour blend (100% whole grain) from amaranth, quinoa, millet, sorghum, teff (provided by ConAgra Food Ingredients, Omaha, Nebr.)
   Brown rice flour (in the given test series, whole grain brown rice flour from Bob's Red Mill, Milwaukie, Oreg. was used. Other whole grain brown rice flours, finer ground, provided by ConAgra, were also tested and were equally suitable).
Citrus pulp fiber (for structure and texture of the finished pizza crust and consistency of the batter): Citri-Fi® 100 FG (33% soluble fiber, 35% insoluble fiber; Fiberstar Inc., River Falls, Wis.)
Dried rice sourdough (recommended for flavor and consistency): Böcker Reis 100 (from rice milling products and starter cultures, total titratable acidity 100, pH ca. 3.4, moisture <7%; Ernst Booker GmbH & Co. KG, Minden, Germany)
HPMC (hydroxypropyl methylcellulose), if a finer crumb structure is desired (Methocel K4M Food Grade, DOW Chemical, New Milford, Conn.)

The remaining ingredients are standard baking ingredients:
Salt for flavor
Sugar for taste, browning and as an energy source for yeast
Yeast as a leavening agent and to contribute a bread-typical flavor
Water

TABLE 1

| Sample No. | 1 | 2 | 3 | 4 | 5 | 6 | 7 |
|---|---|---|---|---|---|---|---|
| Short | Potato- | Potato- | Corn | 3 starch, | 3 starch | 3 starch, | 3 starch, |
| descriptor | tapioca | tapioca 2 | starch | high tapioca | | citrus fiber, | citrus fiber, |
| | | | | | | HPMC | no HPMC |
| Description | wt % total | wt % total | wt % total | wt % total | wt % total | wt % total | wt % total |
| | formulation | formulation | formulation | formulation | formulation | formulation | formulation |
| Corn starch | 0.0 | 0.0 | 37.0 | 10.6 | 10.6 | 10.5 | 10.6 |
| Potato starch | 26.3 | 21.1 | 0.0 | 5.3 | 21.1 | 21.0 | 21.2 |
| Tapioca starch | 21.1 | 15.8 | 0.0 | 21.1 | 5.3 | 5.2 | 5.3 |
| Gluten-free | 5.3 | 15.8 | 15.9 | 15.9 | 15.9 | 15.7 | 15.9 |
| whole grain | | | | | | | |
| flour | | | | | | | |
| Salt | 1.1 | 1.1 | 1.1 | 1.1 | 1.1 | 1.0 | 1.1 |
| Sugar | 2.1 | 2.1 | 2.1 | 2.1 | 2.1 | 2.1 | 2.1 |
| Citrus pulp | 0.0 | 0.0 | 0.0 | 0.0 | 0.0 | 0.8 | 0.8 |
| fiber | | | | | | | |
| HPMC | 1.1 | 1.1 | 1.1 | 1.1 | 1.1 | 1.0 | 0.0 |
| Fresh yeast | — | — | 2.1 | 2.1 | 2.1 | 2.1 | 2.1 |
| Dried yeast | 1.1 | 1.1 | — | — | — | — | — |
| Water | 41.9 | 41.9 | 40.7 | 40.7 | 40.7 | 40.6 | 40.9 |
| SUM | 100 | 100 | 100 | 100 | 100 | 100 | 100 |

TABLE 2

| Sample No. | 8 | 9 | 10 | 11 | 12 | 13 | 14 | 15 |
|---|---|---|---|---|---|---|---|---|
| Short | Tapioca | Potato | Corn | all 3 | no | high | low | no |
| descriptor | starch | starch | starch | starches | citrusfiber | citrusfiber | citrusfiber, | citrusfiber, |
| | | | | | | | low water | low water |
| Description | wt % total | wt % total | wt % total | wt % total | wt % total | wt % total | wt % total | wt % total |
| | formulation | formulation | formulation | formulation | formulation | formulation | formulation | formulation |
| Corn starch | 0.0 | 0.0 | 36.2 | 10.3 | 10.4 | 10.3 | 10.8 | 11.0 |
| Potato starch | 0.0 | 36.2 | 0.0 | 20.7 | 20.8 | 20.5 | 21.5 | 22.1 |
| Tapioca starch | 36.2 | 0.0 | 0.0 | 5.2 | 5.2 | 5.1 | 5.4 | 5.5 |
| Brown rice | 15.5 | 15.5 | 15.5 | 15.5 | 15.6 | 15.4 | 16.2 | 16.5 |
| flour | | | | | | | | |
| Salt | 1.0 | 1.0 | 1.0 | 1.0 | 1.0 | 1.0 | 1.1 | 1.1 |
| Sugar | 2.1 | 2.1 | 2.1 | 2.1 | 2.1 | 2.1 | 2.2 | 2.2 |
| Dried rice | 2.6 | 2.6 | 2.6 | 2.6 | 2.6 | 2.6 | 2.7 | 2.8 |
| sourdough | | | | | | | | |
| Citrus pulp | 0.8 | 0.8 | 0.8 | 0.8 | 0.0 | 1.5 | 0.4 | 0.0 |
| fiber | | | | | | | | |
| Fresh yeast | 2.1 | 2.1 | 2.1 | 2.1 | 2.1 | 2.1 | 2.2 | 2.2 |
| Water | 39.7 | 39.7 | 39.7 | 39.7 | 40.2 | 39.4 | 37.5 | 36.6 |
| SUM | 100.0 | 100.0 | 100.0 | 100.0 | 100.0 | 100.0 | 100.0 | 100.0 |

### Example 2: Procedure of Making Baked Bread Products

The following procedure of making the bread products was followed for samples 1-7:
The ingredients according to Table 1 were mixed together in a Kenwood mixer (1000-2000 g batch, paddle tool, lowest level, 60 sec; followed by scraping of the bowl and another 60 sec on medium level) to make a dough batter;
The dough's were divided into portions: a 550 g portion was put into a 12 inch (30.5 cm) pan and flattened by hand; a 250 g portion was put into a pup loaf pan (5½×3×2 inches; 14×7.6×5.1 cm);
The dough's were proofed at room temperature to height: 30-60 min until pup loaf reached upper edge, which was typically after ca. 40 min;
The dough's were then baked at 425° F. (218° C.) for 25 min in a standard household oven.

The following procedure of making the bread products was followed for samples 8-15:
The ingredients according to Table 2 were mixed (2000-6000 g batch, paddle tool, lowest level, 60 sec; followed by scraping of the bowl and another 60 sec on medium level) to make a dough;
The doughs were divided into portions: a 300 g portion was put into a 12 inches pan and flattened by hand, followed by docking; a 250 g portion was put into a pup loaf pan (5½×3×2 inches);
The doughs were proofed at 90° F. (32° C.), 85% relative humidity, to height, 15-25 min until pup loaf reached upper edge
The doughs were then baked in a rack oven, at 385° F. (196° C.) for 12 min, with 8 sec steam injection at the beginning.

### Example 3: Evaluation of the Baked Bread Products

The results of the evaluation of the baked bread products are shown below in Tables 3 and 4.

The resulting crumb properties were evaluated as to differentiating visual effects and mechanical effects (crumb texture, as also perceived in the mouth or by touching by hand). A same product may have for example a quite good appearance (e.g. fine regular pores), but a bad texture, e.g. a gummy mouth-feel. Or vice versa, the appearance may be bad, e.g. the crumb torn, but the texture may be not objectionable from an organoleptic view point.

The evaluation of the baked products was rated on a scale from 1 to 10 (i.e. from worst to best). On the scale provided, a 1 (worst) was given to a sample when the baked product had a clear disqualifying flaw making the formulation not industrially feasible: for example visually, when the crumb of a pizza crust was torn open like a pita bread; or when the texture was extremely gummy so that the crumb stuck to the mouth similar to a soft caramel. Acceptable properties of a baked product were ranked 5; good properties of such a product were rated from 6 to 7. A 10 would mean that the product would be perfect, as would be expected from an optimal gluten-containing wheat dough product.

Formula Development as of Table 1 was conducted first to find a suitable formulation for gluten-free bread and pizza crust. This set contained no rice sourdough, mostly HPMC as the only hydrocolloid, and the gluten-free 5 grain whole grain flour blend.

Conclusions from these tests shown in Table 3 are:
Tapioca starch contributes moisture and gumminess to the crumb. High amounts (15% or more) create an excessively gummy crumb (samples 1, 2 and 4).
Corn starch contributes to a well-set, dry crumb. Used as the only isolated starch source (37%) together with whole grain (15.9%), it produces undesirable dry and crumbly crumb (sample 3).
Corn starch and tapioca starch have opposite effects and have the potential to balance each other out (samples 4 and 5).
The mix of corn starch (10.6%), potato starch (21.1%) and tapioca starch (5.3%) together with 15.9% whole grain flour was most balanced between wet/gummy and crumbly/dry (sample 5).
The best gluten-free bread could be produced with about 10-11% corn starch, 21% potato starch, 5% tapioca starch, 16% whole grain flour, 1% HPMC, 0.8% citrus pulp fiber, 40% water and the rest as regular baking ingredients (sample 6). It was characterized by a balanced crumb texture (neither too wet nor too dry) and a fine crumb structure (fine pores).
For pizza crusts, omission of HPMC is possible and even desirable for ‘clean label’ purposes. It results in a balanced crumb texture, and a slightly more open porosity, the latter being very acceptable for a pizza crust (Sample 7).
Level of citrus pulp fiber was further optimized in the second set of experiments (see below).
The flavor of the 5-grain flour blend was perceived as somewhat bitter and grassy in some cases. In the next set of experiments, therefore, brown rice flour with a more neutral flavor was used.

TABLE 3

| Sample No. | 1 | 2 | 3 | 4 | 5 | 6 | 7 |
|---|---|---|---|---|---|---|---|
| Short | Potato- | Potato- | Corn | 3 starch, | 3 starch | 3 starch, | 3 starch, |
| descriptor | tapioca | tapioca 2 | starch | high tapioca | | citrus fiber, | citrus fiber, |
| | | | | | | HPMC | no HPMC |
| Overall | 4 | 4 | 3 | 4 | 6 | 7 | 6 |
| evaluation | | | | | | | |
| Scale: 1 (worst) | | | | | | | |
| to 10 (best) | | | | | | | |
| Notes on bread | Somewhat | Gummy | off-flavor, | acceptable, but | Balanced | Balanced (neither | Balanced |
| and pizza quality | gummy | crumb, | dry, | crumb still a | (neither too | too wet nor too | (neither too wet |
| | crumb, | improved | crumbly | little wet and | wet nor too | crumbly/dry), fine | nor too |
| | tendency to | after freezing | crumb | gummy | crumbly/dry) | crumb structure | crumbly/dry), |
| | shrink, | and reheating | | | | | crumb structure |
| | bland flavor | in microwave | | | | | slightly less fine, |
| | | | | | | | Clean label |
| | | | | | | | alternative |

Formula optimization as of Table 2 used brown rice flour and dried rice sourdough (both for an improved flavor), verified the effect of the individual starches, and optimized levels of citrus pulp fiber and water.

Conclusions from these tests shown in Table 4 are:
The effect of tapioca starch (contributing moistness and gumminess) versus corn starch (contributing dryness and crumbliness) in the finished product was confirmed (Samples 8 and 10).
Potato starch tended to produce a dry and starchy mouth-feel in the finished product (sample 9).
Again, the combination of all three starches, similar as above was best (sample 11: about 10% corn starch, 21% potato starch, 5% tapioca starch, 16% brown rice flour). This ratio was maintained in the further following samples (samples 12-15).
Lowering citrus pulp fiber to half the amount (sample 14), combined with lowering water (in order to maintain batter consistency), resulted in a more acceptable quality, however, the crumb started to tear (sample 14).
Excessively high citrus fiber levels (e.g. 1.5%, sample 13) produced a very firm batter that was easy to handle, but the finished product was not acceptable from an organoleptic view point. It was clearly much too dense.

TABLE 4

| Sample No. | 8 | 9 | 10 | 11 | 12 | 13 | 14 | 15 |
|---|---|---|---|---|---|---|---|---|
| Short | Tapioca | Potato | Corn | all 3 | no | high | low | no |
| descriptor | starch | starch | starch | starches | citrusfiber | citrusfiber | citrusfiber, | citrusfiber, |
| | | | | | | | low water | low water |
| Results: | | | | | | | | |
| 1 (worst) to | | | | | | | | |
| 10 (best) | | | | | | | | |
| Crumb | 2 | 4 | 3 | 7 | 5 | 1 | 6 | 6 |
| texture Pizza | (very | (some dry, | (dry | (balanced | (no | (very dense) | (balanced but | (balanced but |
| crust: | gummy) | starchy | mouthfeel, | between | particular | | a little dry) | a little dry) |
| | | mouthfeel) | surface | starchy and | negative | | | |
| | | | cracked) | gummy) | effects | | | |
| | | | | | noted) | | | |
| Crumb | 1 | 3 | 2 | 6 | 5 | 1 | 5 | 5 |
| texture Pan | (extremely | (distinctly | (dry, | (balanced | (no | (very dense) | (balanced but | (balanced but |
| bread: | gummy) | starchy-dry) | crumbly) | between | particular | | a little dry) | a little dry) |
| | | | | starchy and | negative | | | |
| | | | | gummy) | effects | | | |
| | | | | | noted) | | | |

### Example 4: Example of a Gluten-Free Pizza Bread Crust

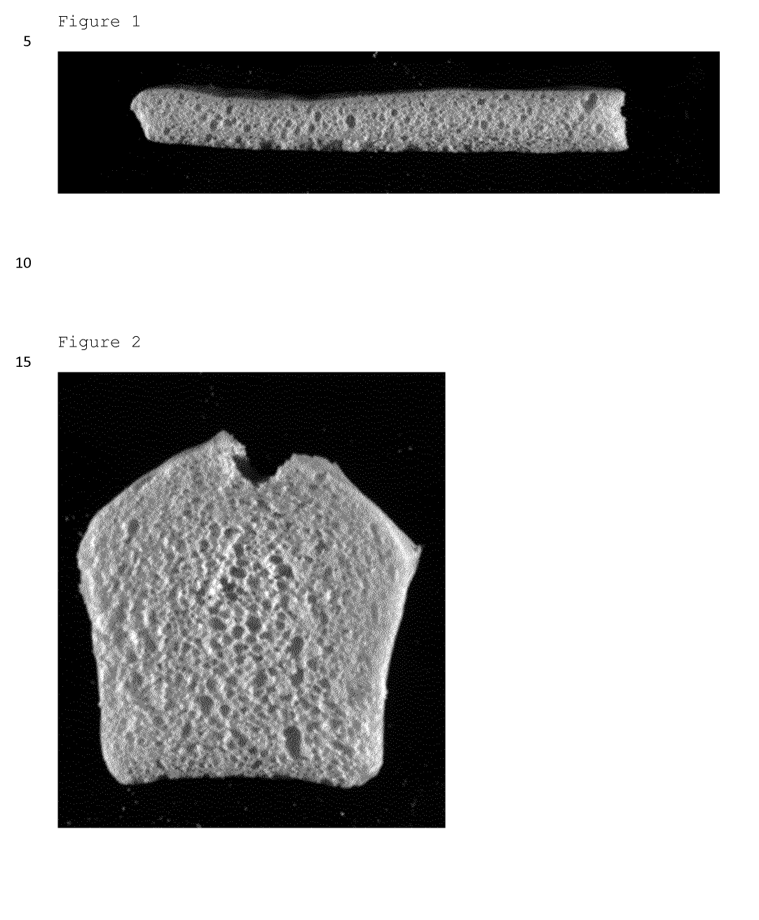

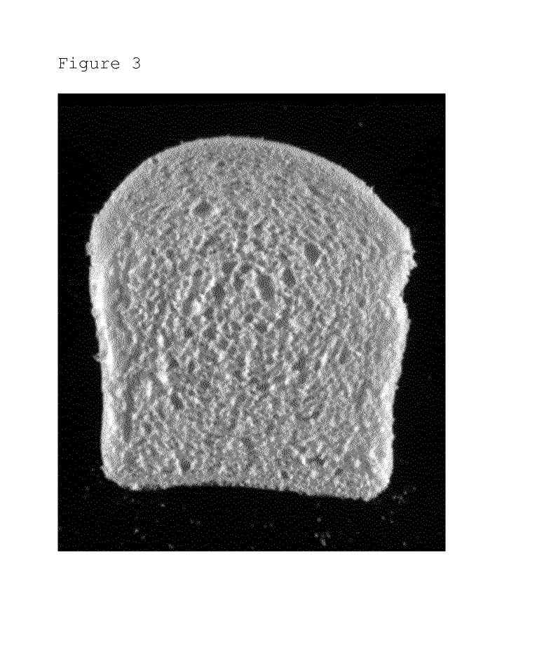

Sample 16 is specifically suitable for thick pan-style gluten-free pizza crust with light, aerated structure (Table 5). The formulation is based on the developed mix of corn starch, potato starch, tapioca starch and 5-grain whole grain flour blend. It contains citrus-fiber and no HPMC. FIG. 1 shows the resulting pizza crust, which is well-aerated and has a regular pore structure. Gluten-free bread from the same formulation is also well-aerated, but has a somewhat irregular crumb structure (FIG. 2).

Sample 17: The bread can be improved by incorporating HPMC into the formulation (Table 6), which causes a more regular uniform crumb structure (FIG. 3). This can be explained by the ability of HPMC to form a gel right at the gas liquid interface of gas bubbles, because it is a surface active hydrocolloid.

Sample 18: A formulation for pizza crust, based on corn starch, potato starch, tapioca starch and brown rice flour is given in Table 7. It contains citrusfiber but no HPMC. Additionally, dried rice sourdough is incorporated to improve flavor and increase water binding.

Sample 19: A formulation for pizza crust, based on corn starch, potato starch, tapioca starch and brown rice flour is given in Table 8. It contains citrusfiber but no HPMC. Additionally, dried rice sourdough is incorporated to improve flavor and increase water binding. Yeast is increased for improved flavour and aeration.

Sample 20: Same as sample 19, but added whey protein for improved crust browning and roasted flavour (Table 9).

TABLE 5
Formulation for gluten-free pizza crust (Sample 16)

| | wt % flour | wt % total |
|---|---|---|
| | basis | formulation |
| Corn starch | 20 | 10.6 |
| Potato starch | 40 | 21.2 |
| Tapioca starch | 10 | 5.3 |
| 5-grain whole grain | 30 | 15.9 |
| flour blend (ConAgra) | | |
| Salt | 2 | 1.1 |
| Sugar | 4 | 2.1 |
| Water | 77 | 40.9 |
| Fresh yeast | 4 | 2.1 |
| Citrusfiber | 1.5 | 0.8 |
| (Citrifi 100 FG, | | |
| Fiberstar) | | |
| SUM | | 100.0 |

TABLE 6
Formulation for gluten-free bread (Sample 17)

| | wt % flour | wt % total |
|---|---|---|
| | basis | formulation |
| Corn starch | 20 | 10.5 |
| Potato starch | 40 | 21.0 |
| Tapioca starch | 10 | 5.2 |
| 5-grain whole grain | 30 | 15.7 |
| flour blend (ConAgra) | | |
| Salt | 2 | 1.0 |
| Sugar | 4 | 2.1 |
| Water | 77 | 40.6 |
| Fresh yeast | 4 | 2.1 |
| HPMC (Methocel K4M, | 2 | 1.0 |
| Dow Chemical) | | |
| Citrusfiber | 1.5 | 0.8 |
| (Citrifi 100 FG, | | |
| Fiberstar) | | |
| SUM | | 100.0 |

TABLE 7
Formulation for gluten-free pizza, with brown
rice flour and rice sourdough (Sample 18)

| | wt % flour | wt % total |
|---|---|---|
| | basis | formulation |
| Corn starch | 20 | 10.3 |
| Potato starch | 40 | 20.7 |
| Tapioca starch | 10 | 5.2 |
| Brown rice flour | 30 | 15.5 |
| Salt | 2 | 1.0 |
| Sugar | 4 | 2.1 |
| Dried rice sourdough | 5 | 2.6 |
| (Boecker Reis 100) | | |
| Water | 77 | 39.7 |
| Fresh yeast | 4 | 2.1 |
| Citrusfiber | 1.5 | 0.8 |
| (Citrifi 100 FG, | | |
| Fiberstar) | | |
| SUM | | 100.0 |

TABLE 8
Formulation for gluten-free pizza, with brown rice flour,
rice sourdough and increased yeast level (Sample 19)

| | wt % flour | wt % total |
|---|---|---|
| | basis | formulation |
| Corn starch | 25 | 13.2 |
| Potato starch | 35 | 18.4 |
| Tapioca starch | 10 | 5.3 |
| Brown rice flour | 30 | 15.8 |
| Salt | 1.5 | 0.8 |
| Sugar | 4 | 2.1 |
| Dried rice sourdough | 5 | 2.6 |
| (Boecker Reis 100) | | |
| Water | 70 | 36.8 |
| Fresh yeast | 8 | 4.2 |
| Citrusfiber | 1.5 | 0.8 |
| (Citrifi 100 FG, | | |
| Fiberstar) | | |
| SUM | 190 | 100.0 |

TABLE 9
Formulation for gluten-free pizza, with brown rice flour, rice
sourdough, increased yeast level and whey protein (Sample 20)

| | wt % flour | wt % total |
|---|---|---|
| | basis | formulation |
| Corn starch | 25 | 12.8 |
| Potato starch | 35 | 17.9 |
| Tapioca starch | 10 | 5.1 |
| Brown rice flour | 30 | 15.4 |
| Salt | 1.5 | 0.8 |
| Sugar | 4 | 2.1 |
| Dried rice sourdough | 5 | 2.6 |
| (Boecker Reis 100) | | |
| Whey protein | 5 | 2.6 |
| (36% protein) | | |
| Water | 70 | 35.8 |
| Fresh yeast | 8 | 4.1 |
| Citrus fiber | 1.5 | 0.8 |
| (Citrifi 100 FG, | | |
| Fiberstar) | | |
| SUM | 195 | 100.0 |

Method for the preparation of the baked bread dough products was as follows:

Mix all the ingredients in a mixer equipped with a paddle tool for 60 sec on lowest level, followed by scraping of the bowl and 60 sec on medium level;

Place a 300 g portion (thin crust) or 450 g portion (thick crust) in a flat pizza pan (diameter 12 inches), spread out and flatten by hand, and docking the dough;

For bread, place a 250 g portion in a rectangular pup loaf pan (about 5×3×2 inches);

Proof at 90° F. (32° C.) and 85% relative humidity until the batter in the pup loaf reaches 10 mm under the rim (typical: 15-25 min); bake at 385° F. (196° C.) for 10-12 min with 8 sec steam injection at the beginning of baking.

Method for Preparing Samples 19 and 20:

Premix dry ingredients (3 min on stir in mixer with paddle tool);

Dissolve yeast in water;

Add water and yeast to the premixture of dry ingredients;

Mix (60 sec on low level, followed by 60 sec on medium level stirring);

Weigh 220 g pieces, round (brown rice flour for dusting); cover with some oil, press into 26 cm pans generating a rim;

Prepare a 250 g portion in pup loaf pan (about 5×3×2 inches) as a control;

Dock;

Proof dough: 18 min, 86° F. (30° C.), 85% humidity (check that pup loaf has risen to 5 mm under edge);

Bake dough: 525° F. (274° C.), 5 min, 8 sec steam injection at the beginning of baking.

1. A gluten-free or gluten-reduced bread dough comprising:
5-15 wt % corn starch;
10-25 wt % potato starch;
2-15 wt % tapioca starch;
gluten-free or gluten-reduced flour; and
water.

2. The dough according to claim 1, comprising 5-37 wt % of a gluten-free or gluten-reduced flour.

3. The dough according to claim 2, wherein the gluten-free or gluten-reduced flour is selected from the group consisting of whole grain flour and rice flour.

4. The dough according to claim 1, further comprising up to 2 wt % methylcellulose.

5. The dough according to claim 1, comprising 7-12 wt % corn starch.

6. The dough according to claim 1, comprising 15-23 wt % potato starch.

7. The dough according to claim 1, comprising 3-10 wt % tapioca starch.

8. The dough according to claim 1, further comprising 0.2-1.2 wt % citrus fiber.

9. The dough according to claim 1 comprising:
10-11 wt % corn starch;
20-22 wt % potato starch;
5-6 wt % tapioca starch;
0.6-1.0 wt % citrus fiber;
10-20 wt % gluten-free flour; and
water.

10. The dough according to claim 1 comprising:
12-14 wt % corn starch;
17-19 wt % potato starch;
5-6 wt % tapioca starch;
0.6-1.0 wt % citrus fiber;
10-20 t % gluten-free flour; and
water.

11. The dough according to claim 1, wherein the dough does not comprise egg proteins, dairy proteins and soy proteins.

12. The dough according to claim 1, wherein the dough does not comprise a gum.

13. Method for the preparation of a gluten-free or gluten-reduced bread dough product comprising the steps of:
a) mixing ingredients comprising 5-15 wt % corn starch, 10-25 wt % potato starch, 2-15 wt % tapioca starch, gluten-free or gluten-reduced flour, and water, to produce a dough;
b) shaping the dough into a form; and
c) baking the dough in an oven.

14. The method according to claim 13, wherein steam is injected into the oven during the baking process or during part of the baking process.

15. A baked dough product prepared by baking a gluten-free or gluten-reduced bread dough comprising:
5-15 wt % corn starch;
10-25 wt % potato starch;
2-15 wt % tapioca starch;
gluten-free or gluten-reduced flour; and
water.

16. A baked dough product obtainable by the method of claim 13.

17. The baked dough product according to claim 15, which is in a form selected from the group consisting of a pan bread, a pizza bread crust, a tortilla, a Panini bread, a pretzel, a pie and a sandwich bread product.

18. (canceled)
